(19) United States
(12) Patent Application Publication
(10) Pub. No.: US 2009/0283043 A1
(43) Pub. Date: Nov. 19, 2009

(54) Teat Cup Rubber Liner for Use in a Teat Cup

(76) Inventors: Magnus Wiethoff, Oelde (DE); Anne Schulze Schwering, Munster (DE); Kathrin Lincke, Turkheim (DE); Reinhard Frenser, Rheda-Wiedenbruck (DE)

Correspondence Address: SMITH LAW OFFICE, 8000 EXCELSIOR DRIVE, SUITE 301, MADISON, WI, 53717, US

(21) Appl. No.: 12/085,477

(22) PCT Filed: Nov. 24, 2006
(86) PCT No.: PCT/EP2006/011278

§ 371 Date: Jul. 7, 2008

(30) Foreign Application Priority Data
Nov. 24, 2005 (DE) 10 2005 056 384.8
Apr. 28, 2006 (DE) 10 2006 019 830.1

(51) Int. Cl. A01J 5/08

(52) U.S. Cl. 119/14.49; 119/14.5

(57) ABSTRACT

For a teat cup, a teat cup rubber liner (1) is proposed having a head part (2) having an inlet orifice (3) for a teat of an animal, this inlet orifice (3) being limited by an annular tube (4) and having a shaft part (5) connected to the head part (2), wherein, between the head part (2) and the shaft part (5), a region (6) is provided which makes possible relative motion between the head part (2) and the shaft part (5).

The object of the invention concerns a teat cup rubber liner for use in a teat cup with a head part that has an inlet opening for a teat of an animal, whereby this is delineated by an annular tube and with a shaft part connected to the head part.

For the milking of an animal, especially a cow, a milking machine is used that has several teat cups. The teat cups are usually connected to a collecting unit through a milk tube. The milked milk is passed from the collecting unit to a milk tank. Moreover, it is known that the teat cup can be connected directly through a milk tube to a line of the milking system without an intermediate collecting unit being connected.

The teat cup has a sleeve, in which a teat cup rubber liner is arranged. Various embodiments of a teat cup rubber liner are known. Thus, for example, WO 2005/070197 describes a teat cup rubber liner to be used in a teat cup with a head part, where a sealing lip is provided that has an inlet orifice for the teat. The head part is connected to a shaft part.

From DE 100 18 870 A1 a teat cup rubber liner is known for use in a teat cup with a head part. The head part has an inlet orifice for a teat of an animal, whereby this opening is delineated with an annular tube. A shaft part is connected to the head part.

A problem during the milking of an animal is that the teat cup rubber liner must not constrict the teat. Especially at the end of a milking process undesirable climbing of the milk cup on the teat may occur. In the region of the Fürstenberg vein ring, at the transition from the teat to the udder base, numerous blood vessels and lymph vessels are located. This region is relatively sensitive, so that when the milk cup climbs up, constricting of the blood vessels and lymph vessels may occur. This leads to a reduced milk flow or to negative behavior of the animal during milking. However, in order to achieve complete stripping of the udder, a post-milking operation is necessary. As a result of this, the milking time may become longer, which may have effects on the condition of the teats.

On the other hand, there is a problem that the anatomy and the size of the teats of several animals and even of the same animal may be very different.

Based on this, the goal of the present invention is to provide a teat cup rubber liner with which protective and, especially, fast milking is made possible.

This task is solved according to the invention by a teat cup rubber liner to be used in a teat cup with the characteristics of Claim 1. Advantageous further developments and embodiments of the teat cup rubber liner according to the invention are the object of the subclaims.

The teat cup rubber liner according to the invention to be used on a teat cup with a head part that has an inlet orifice for a teat of an animal, whereby the inlet orifice is delineated by an annular tube, and with a shaft part connected to the head part, is characterized by the fact that between the head part and the shaft part at least one region is provided that makes relative movement between the head part and the shaft part possible.

With this design of the teat cup rubber liner according to the invention it is achieved that improved adaptation of the teat cup rubber liner to a teat is made possible.

Hereby, the relative movement between the head part and the shaft part has a positive effect since, for example, the teats of an animal may project from the udder at different angles, so that, as a result of the relative movement between the head part and the shaft part, better adaptation to the anatomy of the animal is made possible. The relative movement between the head part and the shaft part can also be achieved by the fact that the head part and the shaft part can be moved toward one another or away from one another. This also has the advantage that when the head part of the shaft adheres well, the teat is massaged or stimulated by means of a pronounced vertical movement of the teat during the entire milking process, through which an improvement of the milking process is achieved. Caused by the pulsing, collapsing or closing of the teat cup rubber liner, the teat has a tendency to be pushed out of the teat cup rubber liner, which has a negative effect on the adherence between the teat cup rubber liner and the teat. A relative movement between the head part and the shaft part compensates for the movement between the teat and the teat cup rubber liner at least partially.

The region between the head part and the shaft part is preferably designed so that this forms a joint. Hereby, several joints may also be provided.

An especially preferred embodiment of the region is regarded to consist in that the region has a wavy cross-section. In this way, a relative movement between the head part and the shaft part in space becomes possible. Moreover, movement in the longitudinal direction of the teat cup rubber liner is permitted.

The region between the head part and the shaft part is preferably made in the form of a film joint. Especially preferred is an embodiment in which the region is designed to be elastic. According to a still further advantageous embodiment of the teat cup rubber liner according to the invention, it is proposed that the region be made of a material that is different from the material of the shaft part and/or of the head part, preferably a material with higher elasticity. The oval contour has the additional advantage that a filler can be made available in the buffer space, since the oval contour can be extended into an approximately round contour. This is not possible in the case of a circular contour.

Furthermore, it is proposed that the annular tube of the teat cup rubber liner have an essentially elliptical cross-section. The elliptical cross-section does not necessarily have to be an elliptical cross-section in the mathematical sense. It is also possible to have an oval cross-section. As a result of the advantageous further development, it is achieved that the height of the head is reduced, through which, especially in the case of short teats, they can penetrate sufficiently into the shaft part. Due to the reduced distance from the upper edge of the head part to the beginning of the shaft part, a gentler milking is achieved in the case of short teats.

It is especially advantageous when the annular tube has a cross-section with a clear height and a clear width such that the ratio of the height to width is less than 0.9, and preferably lies between 0.75 and 0.4, especially 0.5. In this way the possibility is created that the head part is not pulled inward, that is, in the direction of the shaft part, when attached to the teat.

According to a further advantageous embodiment of the teat cup rubber liner according to the invention, it is proposed that a rib be provided within the annular tube and at least over a part of the periphery of the annular rib. This rib prevents the head part from being pulled in during the milking process in the direction of the shaft part and to the teat, and thus leading to constrictions and/or air seal breakage. When several ribs are provided it is proposed it these be preferably arranged equidistant from one another.

In order to simplify the manufacture of the annular tube, according to a still further advantageous embodiment of the teat cup rubber liner according to the invention, it is proposed that, viewed from the peripheral direction, the annular tube have a joining region. Preferably hereby an arrangement in which the joining region is designed with a positive locking joint and/or non-positive locking joint is preferred. For this purpose, the joining region can be designed with the appropriate locking means. Thus, these locking means may have a groove into which a corresponding protrusion penetrates.

In order to ensure that the joint is not broken, the joining region may be formed by an adhesive bond. As a result of the adhesive bond, a tight joint is achieved which is especially advantageous when, as explained below, the annular tube is filled with a fluid or a fluid mixture at least partially.

According to a still further advantageous embodiment of the teat cup rubber liner according to the invention, it is proposed that the annular tube be filled with a fluid or fluid mixture at least partially.

If the fluid or fluid mixture is an incompressible fluid, then it is advantageous for the cross-section of the annular tube not to be circular. Hereby an elliptical design of the annular tube is preferred. There is also the possibility for the annular tube to have a polygonal cross-section. Such a design of the annular tube has the advantage that when the teat is immersed into the annular tube, the fluid can be displaced relatively easily without expansion of the material of the annular tube being necessarily required.

The fluid is preferably a food-compatible fluid, which is liquid, especially in the temperature range between −30° C. and 100° C. and does not evaporate. When the head part is made of silicone, it is advantageous if the fluid does not attack the silicone. The head part is preferably made of a plastic or a plastic mixture. Especially we are dealing here with a thermoplastic elastomer (TPE). When the annular tube is filled with a fluid, then the plastic, of which at least the annular tube is made, is selected so that the fluid and the plastic are adjusted to one another, especially so that the fluid does not attack the plastic. The fluid is preferably chosen so that it cannot diffuse through the annular tube. To the extent that the fluid concept is used, it can also be a mixture of liquids or gases, or a combination of mixtures of liquids or gases. Optionally, the inner surface of the annular tube may be provided with a coating. This coating may form a diffusion barrier.

The fluid is preferably glycerol or propylene glycol. Especially, the annular tube is filled with a saturated glycerol-water or propylene glycol-water mixture, so that a constant volume is achieved in the annular tube.

According to a still further advantageous embodiment of the teat cup rubber liner, it is proposed that the head part be made of a material that is softer in comparison to the material of the shaft part. In this way, it is achieved that a soft head part has an even better adjustment behavior to the teat. A soft head part also has the additional advantage that it can adjust better to teats with different dimension and position on the udder. A harder shaft part has the advantage that, with the buckling strength remaining the same, the wall thickness can be reduced, which results in savings in material. Moreover, the mechanical load that the shaft part can accept, and thus the lifetime of the teat cup rubber liner, are increased. The teat cup rubber liner according to the invention is preferably designed so that the head part and the region or the shaft part and the region or the head part and the region and the shaft part are produced by a two-component injection method. The manufacturing can be done simultaneously or in series. This method of manufacture also makes it possible to use different materials. Optionally in the transition region between shaft part, head part and/or the regional structures, especially microstructures or macrostructures can be provided in order to increase adhesion.

The material from which the teat cup rubber liner is made preferably has a hardness between 28 and 52 Shore (A), especially between 32 and 42 Shore (A).

Further details and advantages of the invention will be explained with the aid of a practical example shown in the drawing, without the object of the invention being limited to this concrete practical example.

The following are shown:

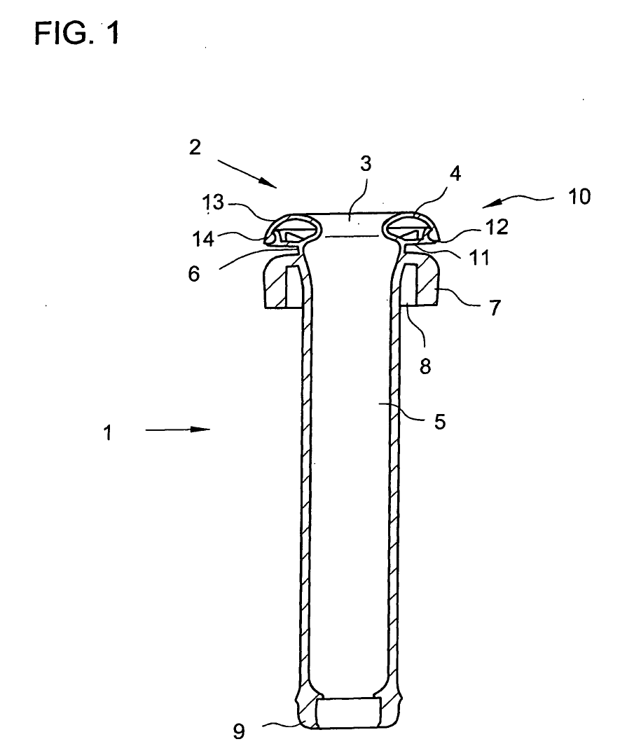

FIG. 1 is a teat cup rubber liner in cross section.

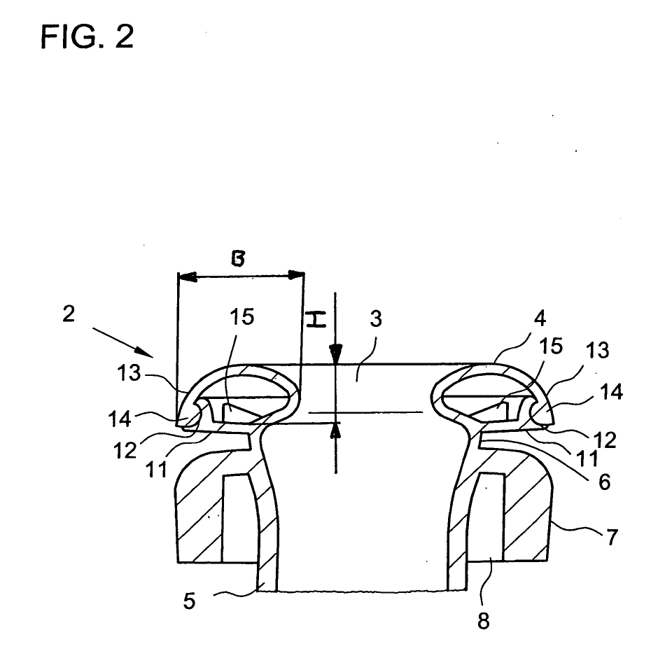

FIG. 2 shows an enlargement of a section of the teat cup rubber liner in a longitudinal section.

FIG. 1 shows schematically a practical example of a teat cup rubber liner 1 to be used in a teat cup. The teat cup rubber liner 1 has a head part 2. The head part 2 has an inlet orifice 3 through which a teat of an animal can be introduced into the teat cup rubber liner. The inlet orifice 3 is delineated by an annular tube 4. A shaft part 5 is connected to the head part 2.

A region 6 is provided between head part 2 and shaft part 5 that makes relative movement between the head part 2 and the shaft part 5 possible. In the practical example shown, the region 6 is designed to be essentially wavy, so that with the aid of this design a relative movement between the head part and the shaft part is made possible, especially when a teat of an animal is introduced into the teat cup rubber liner through the inlet orifice 3.

The region 6 can be made of a material which is softer and/or more elastic than the material of the shaft part 5 or head part 2.

A supporting edge 7 is formed on shaft part 5. The supporting edge 7 surrounds the shaft part 5 with the formation of an annular gap 8. A sleeve of a teat cup, which is not shown, can be introduced into annular gap 8 so that the sleeve is joined to the teat cup rubber liner. A connecting sleeve 9 is provided at the lower section of shaft part 5, serving for joining to a milk tube.

In the practical example shown in FIG. 1, the annular tube 4 has an essentially elliptical cross-section. The elliptical design of the annular tube leads to good sealing of the teat in the region of head part 2.

Viewed in the peripheral direction, the annular tube 4 has a joining region 10. This joining region is formed by positive locking. For this purpose, in a wall section 11 of annular tube 4, a recess 12 with back cut [literal translation] is provided, while in a wall section 13 a bead 14 is provided that can be introduced into the recess. The formation of the connecting region provides a locking joint. To secure the joint, the wall sections in the joining region can be adhered to one another. As a result of the locking joint and especially by the adhesion, exit of fluid from the annular tube is prevented.

The annular tube 4 may have a joint, which is not shown, through which a fluid can be introduced into the annular tube 4. The introduction of fluid into the annular tube can also be done, for example, with a hollow needle with which the fluid is injected into the annular tube.

FIG. 2 shows a further practical example of a teat cup rubber liner according to the invention. The practical example shown in FIG. 2 agrees substantially with the practical example according to FIG. 1, so that the same reference numbers are used for the same components.

As a difference from the embodiment according to FIG. 1, the teat cup rubber liner according to FIG. 2 has an annular tube 4 in which ridges 15 are arranged. The ridges 15 prevent the head part 2 from being pulled downward and inward under the influence of vacuum when the teat cup rubber liner is attached, and so it prevents constrictions and/or entry of air.

The head part 2 is preferably made of a material that is softer than the material of the shaft part 5. Especially, the teat cup rubber liner is made of one part. Especially preferred hereby is a manufacture of the teat cup rubber liner in which the head part 2 and the region 6 or the shaft part 5 and the region 6 or the head part 2 and the region 6 and the shaft part 5 are produced by the two-component injection method.

From the representation in FIG. 2, it can be seen that the ratio of the clear height H of the annular tube to the clear width B is smaller than 1. Especially, the ratio between the clear height and the clear width is 0.5. The inside diameter of the annular tube 4 corresponds essentially to the inside diameter of the shaft part in the region of the head part.

Preferably the annular tube 4 is filled with a fluid or fluid mixture. The fluid is preferably a saturated glycerol- or propylene glycol-water mixture. Preferably, glycerol or propylene glycol or one of the two in a mixture with water is used as fluid. This applies preferably when the annular tube is made of silicone. The annular tube 4 is also formed with the fluid in such a way that the annular tube 4 is deformable when a teat is introduced into the shaft part 5 through the head part 2.

Especially preferred is an embodiment of a teat cup rubber liner in which the depth of the groove, that is, the distance of the sleeve from the inside diameter to the outer wall of the groove is less than 1.5 mm. The ratio of the wall thicknesses should lie preferably between 0.5 and 1, especially at 0.75.

In an especially advantageous embodiment, the wall section 11 is designed so that it runs at an angle toward the outside upward. The angle between wall section 11 and the rotational axis should be between 89° and 60°, preferably at 86.5°. This makes sense especially during the rinsing through the head since the slanting ensures that no residual rinsing water remains on the teat cup rubber liner.

The distance between the head part and shaft should be small, preferably between 0.5 mm and 5 mm, especially at 3 mm.

### REFERENCE LIST

1 Teat cup rubber liner
2 Head part
3 Inlet orifice
4 Annular tube
5 Shaft part
6 Region
7 Supporting edge
8 Annular gap
9 Connecting sleeve
10 Joining region
11 Wall section
12 Recess
13 Wall section
14 Bead
15 Rib

1. A teat cup rubber liner for use in a teat cup with a head part with an inlet orifice for a teat of an animal, whereby this is delineated by an annular tube and with a shaft part connected to the head part, characterized by the fact that at least one region is provided between the head part and the shaft part that permits relative movement between the head part and the shaft part.

2. The teat cup rubber liner according to claim 1, characterized by the fact that the region is formed in a jointed manner.

3. The teat cup rubber liner according to claim 1, characterized by the fact that the region has a wavy cross-section.

4. The teat cup rubber liner according to claim 1, characterized by the fact that the region is designed to be elastic.

5. The teat cup rubber liner according to claim 1, characterized by the fact that the region is made of a material which is different from the material of the shaft part and/or of the head part, preferably having higher elasticity.

6. The teat cup rubber liner according to claim 1, characterized by the fact that the annular tube has an essentially elliptical cross-section.

7. The teat cup rubber liner according to claim 1, characterized by the fact that the annular tube has a cross-section with a clear height (H) and a clear width (B), whereby the ratio of the height to width is smaller than 0.9, preferably lying between 0.75 and 0.4, especially at 0.5.

8. The teat cup rubber liner according to claim 1, characterized by the fact that the within the annular tube and at least over a part of the periphery, at least one rib is provided.

9. The teat cup rubber liner according to claim 8, characterized by the fact that at least two ribs are provided, whereby these are preferably equidistant to one another.

10. The teat cup rubber liner according to claim 1, characterized by the fact that annular tube has a joining region viewed in the peripheral direction.

11. The teat cup rubber liner according to claim 10, characterized by the fact that the joining region is formed by positive- or non-positive locking.

12. The teat cup rubber liner according to claim 10, characterized by the fact that the joining region is formed by an adhesive bond.

13. The teat cup rubber liner according to claim 1, characterized by the fact that the annular tube is filled with a fluid at least in part.

14. The teat cup rubber liner according to claim 1, characterized by the fact that the head part is made of a material that is softer than the material of the shaft part.

15. The teat cup rubber liner according to claim 1, characterized by the fact that the head part and the region or the shaft part and the region or the head part and the region and the shaft part are produced by the two-component injection method.
